(19) United States
(12) Patent Application Publication
(10) Pub. No.: US 2009/0231831 A1
(43) Pub. Date: Sep. 17, 2009

(54) FLAT PANEL DISPLAY AND BACKLIGHT MODULE THEREOF

(75) Inventors: Chun-Chung HSIAO, Caotun Township (TW); Yi-Sing Peng, Sinwu Township (TW); Sung-Po Chen, Yilan City (TW); Hsin-Tao Huang, Jhubei City (TW)

Correspondence Address: Muncy, Geissler, Olds & Lowe, PLLC, P.O. BOX 1364, FAIRFAX, VA, 22038-1364, US

(73) Assignee: KiSmart Corp.

(21) Appl. No.: 12/170,054

(22) Filed: Jul. 9, 2008

(30) Foreign Application Priority Data
Mar. 13, 2008 (TW) 97108904

(51) Int. Cl. F21V 9/16

(52) U.S. Cl. 362/84

(57) ABSTRACT

The invention is related to a flat panel display and a backlight module thereof. The backlight module comprises a light source and a plurality of wavelength converters. The light source formed by some arranged luminous elements would radially emit light with an optical wavelength individually. These wavelength converters are near the light source and convert the light with the wavelength. The converted light with another wavelength is radially emitted, in which a portion of the converted light with another wavelength is emitted outward directly from the wavelength converter, while the other portion thereof is emitted from the wavelength converter toward the other wavelength converters.

### RELATED APPLICATIONS

This application claims priority to Taiwan Application Serial Number 97108904, filed Mar. 13, 2008, which is herein incorporated by reference.

### BACKGROUND

1. Field of Invention

This invention is related to a backlight module, and more particularly to a backlight module of a flat panel display for providing multiple viewing aspects.

2. Description of Related Art

An illuminant of a traditional backlight module of the Liquid Crystal Display (LCD) provides visible light thereof. Normally, the illuminants can be Cold Cathode Fluorescent Lamps (CCFL), External Electrode Fluorescent Lamps (EEFL), Light Emitting Diodes (LED), Carbon Nanotubes (CNT), Flat Fluorescent Lamps (FFL) or Organic Light Emitting Displays (OLED).

For example, the CCFL is made by first applying a phosphor layer (e.g. phosphorous sludge) on an inner surface of a vacuum tube thereof; then, filling a small amount of inert gas and mercury vapor into the vacuum tube and sealing the vacuum tube. Therefore, the mercury vapor generates ultraviolet light by bombarding the mercury vapor during an electrode discharging process. The ultraviolet light collides with the phosphor layer and is converted into visible light.

The phosphorous sludge used for making the phosphor layer is poured into the vacuum tube. Gravity forces the phosphorous sludge to flow downward when the vacuum tube is in a vertically standing position during a traditional CCFL manufacturing process. However, the phosphorous sludge is not evenly distributed over the whole inner surface of the vacuum tube, let alone to distribute the phosphorous sludge in a large CCFL vacuum tube.

To downsize the LCD having CCFL illuminants, one of the considerations is to narrow down the space between the panel and the illuminant. However, if the space between the panel and the illuminant is not narrowed down properly, beam interference and reflection occur and thus amplifies the luminance differentials. This phenomenon is called the “Mura Effect” and degrades the illumination of the LCD.

When the CCFL is implemented in a dual-screened display, the visible light is emitted from the CCFL to pass through one screen thereof. Nevertheless, the visible light will be lost gradually due to being blocked by optical plates (e.g., diffusion plate) therein. Thus, the visible light is unable to arrive to the other screen therein for complementary illumination, and the “Mura Effect” may still be present in a dual-screened displayer.

Because the “Mura Effect” of CCFL illuminated LCDs degrades the illumination quality and cannot be resolved, CCFL illuminated LCDs cannot be downsized and therefore become less competitive in the commercial market. Therefore, the related industries must overcome the mentioned drawbacks and develop an advanced solution of a multi-sided LCD to both overcome the “Mura effect” and be able to downsize the LCD, particularly in thickness.

### SUMMARY

In view of the foregoing, a first aspect of the present invention is to provide a backlight module to prevent the “Mura Effect” from occurring during the illumination process.

According to a second aspect of the present invention, a backlight module provides uniform illumination for each screen or each position on one screen.

According to a third aspect of the present invention of the backlight module to promote a solution to downsize the dimensions.

According to a fourth aspect of the present invention of the backlight module to downsize the flat panel display.

According to a fifth aspect of the present invention of the backlight module to provide multiple types of luminous elements in different arrangements.

Therefore, the present invention provides a first backlight module in a flat panel display. The backlight module comprises a light source and a plurality of wavelength converters. The light source is formed by arranging multiple luminous elements, and the luminous elements radially emit a light with a first wavelength individually. These wavelength converters are placed near the light source. When arriving at the wavelength converters, the light with the first wavelength is converted into a light with a second wavelength by each of the wavelength converters. A portion of the light with a second wavelength is emitted outward directly from the wavelength converter, while the other portion thereof is emitted from the wavelength converter toward the other wavelength converters.

Another backlight module according to the present invention comprises a light source and a wavelength converter. The light source is formed by arranging multiple luminous elements. The luminous elements radially emit light with a first wavelength individually. The wavelength converter is circular and surrounds the light source.

When arriving at the wavelength converter, the light with the first wavelength is converted into a light with a second wavelength by the wavelength converter. A portion of the light with a second wavelength is emitted outward directly from a position of the wavelength converter, while the other portion thereof is emitted from the position of the wavelength converter toward the rest positions of the wavelength converter.

Therefore, in the embodiments of the present invention, flat panel displays providing multiple viewing aspects are provided. In one embodiment, the flat panel display has some display panels and the first backlight module, in which these display panels encircle a holding space that contains the backlight module. Each wavelength converter as introduced above corresponds to one of the display panels and provides light with the second wavelength for all of the display panels.

In another embodiment, the flat panel display has a circular display panel and the second backlight module, in which the circular display panel encircles a holding space for containing the second backlight module. The backlight module in the holding space faces the circular display panel, and provides the light with the second wavelength for the circular display panel.

### BRIEF DESCRIPTION OF THE DRAWINGS

The structure and the technical means adopted by the present invention to achieve the above and other objectives can be best understood by referring to the following detailed description of the preferred embodiments and the accompanying drawings, where:

FIG. 1 is a schematic view of a flat panel displayer according to a first embodiment of the present invention.

FIG. 2 is a schematic view showing the movements of the two lights with the first and second wavelengths according to the first embodiment of the present invention.

FIG. 3 is a schematic view of the wavelength converters supported by supporters according to the first embodiment of the present invention.

FIG. 4 is a schematic view of an arrangement of the luminous elements in an array type in the present invention.

FIG. 5 is a schematic view of an arrangement of the luminous elements in a staggered order in the present invention.

FIG. 6A is a schematic view of an arrangement of the luminous elements in a triangular shape in the present invention.

FIG. 6B is a schematic view of an arrangement of the luminous elements in a rectangular shape in the present invention.

FIG. 7 is a schematic view of an arrangement of the luminous elements in a ring shape in the present invention.

FIG. 8 is a schematic view of a flat panel displayer according to a second embodiment of the present invention.

FIG. 9 is a schematic view of a wavelength converter supported by supporters according to the second embodiment of the present invention.

### DESCRIPTION OF THE PREFERRED EMBODIMENTS

It is to be understood that the following disclosure provides one or more preferred embodiment, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

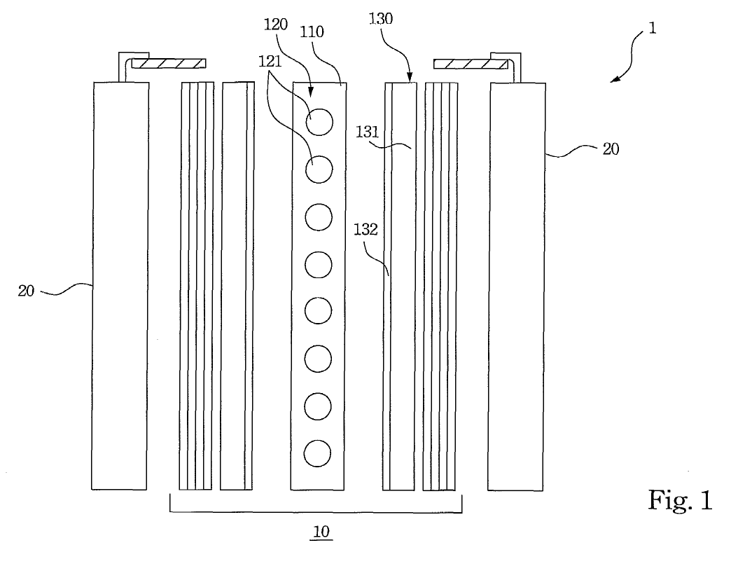

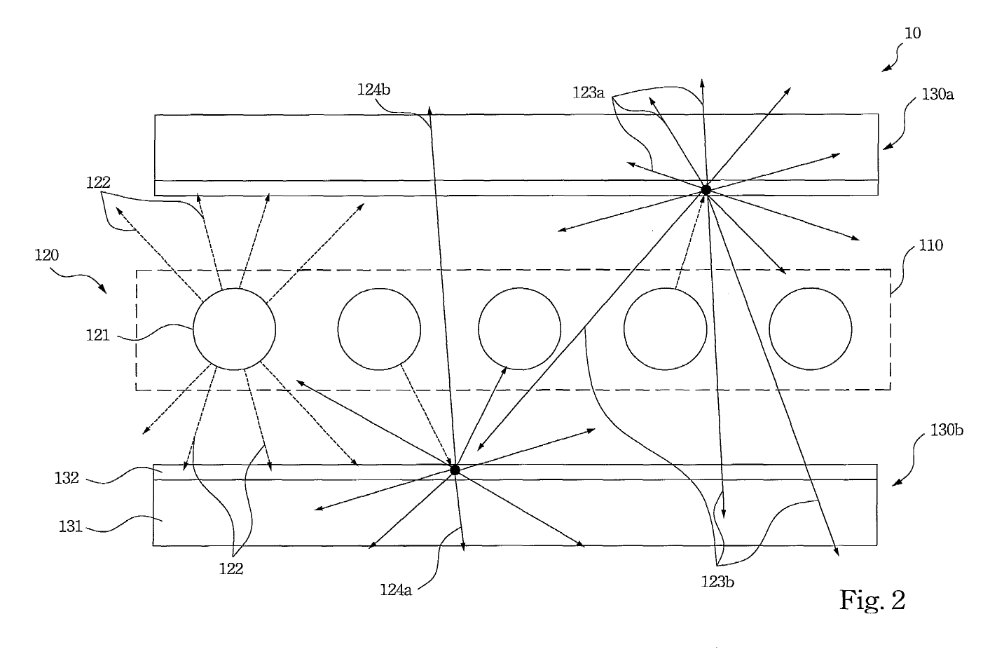

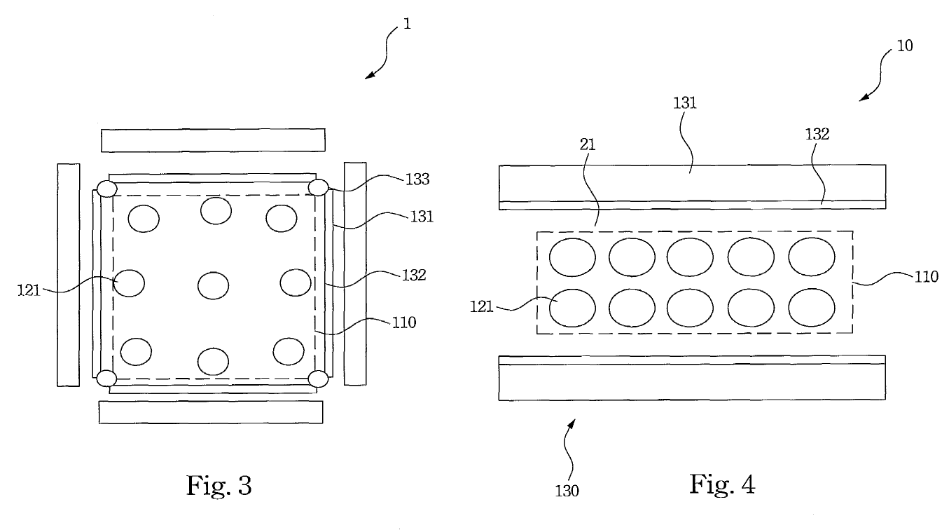

Refer to FIG. 1 and FIG. 2. FIG. 1 is a schematic view of a flat panel display according to a first embodiment of the present invention, and FIG. 2 is a schematic view of movements of the lights according to the first embodiment of the present invention. A flat panel display 1 and its backlight module 10 are disclosed in the present invention. The backlight module 10 comprises a light source 120 and at least one wavelength converter 130. The wavelength converter 130 is placed near the light source 120. The light source 120 is formed by arranging some luminous elements 121, and the luminous elements 121 radially emit a light 122 with a first wavelength individually. Each of the luminous elements 121 could be a short wavelength ultraviolet lamp (UVC lamp for short) or a blue light LED etc. The light 122 can be ultraviolet light from the UVC lamp, which is a kind of a light with an invisible optical wavelength, where the invisible optical wavelength is shorter than 280 nm (e.g. 200 nm˜280 nm, 250 nm˜260 nm or 253.7 nm). The light 122 can be a light with a blue ray wavelength from the blue light LED and the blue ray wavelength for example is within 430 nm˜490 nm.

Note that the luminous elements 121 arranged in different arrangements in a lamp holder 110 can be a different shape for providing illumination on each aspect of viewers depending on the figure of the flat panel display 1, and the number of the screens that the flat panel display 1 owns. The detailed embodiments of the arrangement will be introduced in further paragraphs.

Each wavelength converter 130 comprises at least one substrate 131 and at least one converting layer 132. The converting layer 132 is a layer in/on the substrate 131, and can be made with materials including phosphor power, sensitization substance, fluorescent color converting medium, organic complex substance, sensitizing dye, quantum dot based substance, quantum wire based substance, quantum well based substance and theirs combinations thereof.

The substrate 131 can be any appropriate optical element used in the backlight module 10 to carry the converting layer 132. The substrate 131 can be a flexible optical element, a stiff optical element or any other type of optical element. These optical elements can be supported by some supporters 133. The flexible optical element can be an optical diffuser film, a brightness enhancement film, a dual brightness enhancement film or multiple layers comprising a combination of these elements. The stiff optical element can be a diffusion plate, a prism plate, a lenticular sheet, an optical polarizing plate or multiple layers comprising a combination of these materials.

Each substrate 131 can be made by materials such as plastic, rubber, glass, quartz and theirs combinations thereof. The plastic particularly includes poly(methyl methacrylate) (PMMA), polystyrene (PS), methyl methacrylate-co-styrene (MS), polycarbonate (PC), Polyethylene Terephthalate (PET), polyimide, and a fabric made by theirs combinations thereof.

In the first embodiment, if the wavelength converters 130 such as top and bottom wavelength converters 130a, 130b shown in FIG. 2, are plural, the UVC lamps transmit the ultraviolet light 122 radially to the top and bottom wavelength converters 130a, 130b respectively. The top and bottom wavelength converters 130a, 130b can be either flat or flexible depending on the figure or the screen numbers of the flat panel display 1. The top and bottom wavelength converters 130a, 130b are positioned near the lamp holder 110 and the UVC lamps.

After the ultraviolet light arrives at the top wavelength converter 130a, the converting layer 132 of the top wavelength converter 130a converts the ultraviolet light (i.e. the light 122) into light with an aimed optical wavelength (i.e. light 123a and 123b with a second wavelength in FIG. 2) and radially emits the ultraviolet light (i.e. the light 122) respectively. Note that a portion of the light with aimed optical wavelength (i.e. the portion of the light 123a in FIG. 2) will be emitted outward directly from the top wavelength converter 130a, and the other portion of the light with aimed optical wavelength (i.e. the light 123b in FIG. 2) will be emitted from the top wavelength converter 130a towards the bottom wavelength converter 130b.

After the ultraviolet light arrives at the bottom wavelength converter 130b, the converting layer 132 of the bottom wavelength converter 130b will convert the ultraviolet light (i.e. the light 122) into light with aimed optical wavelength (i.e. light 124a and 124b with a second wavelength in FIG. 2) and radially emits light with aimed optical wavelength respectively. Note that a portion of the light with the aimed optical wavelength (i.e. portion of the light 124a in FIG. 2) will be emitted outward directly from the bottom wavelength converter 130b, and the other portion of the light with the aimed optical wavelength (i.e. the light 124b in FIG. 2) will be emitted from the bottom wavelength converter 130b towards the top wavelength converter 130a.

In view of that, when the other portion of the light with the aimed optical wavelength (i.e. the light 123b or 124b in FIG. 2) is emitted to the rest of the wavelength converters 130, the other portion of the light with the aimed optical wavelength (i.e. the light 123b or 124b in FIG. 2) can provide complementary illumination for the portion of the light 123a or 124a emitted directly from the top or bottom wavelength converter 130a or 130b. Thus, the backlight module 10 uniformly provides illumination to each wavelength converter 130 of the flat panel displayer 1.

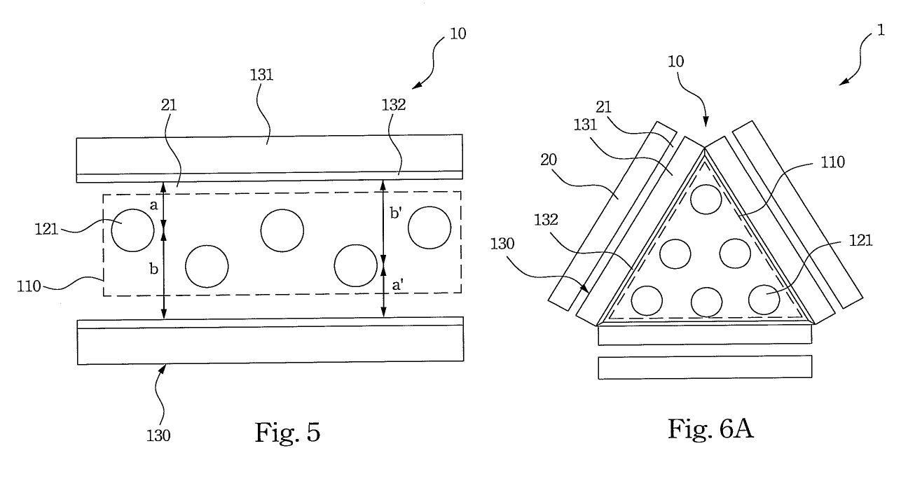

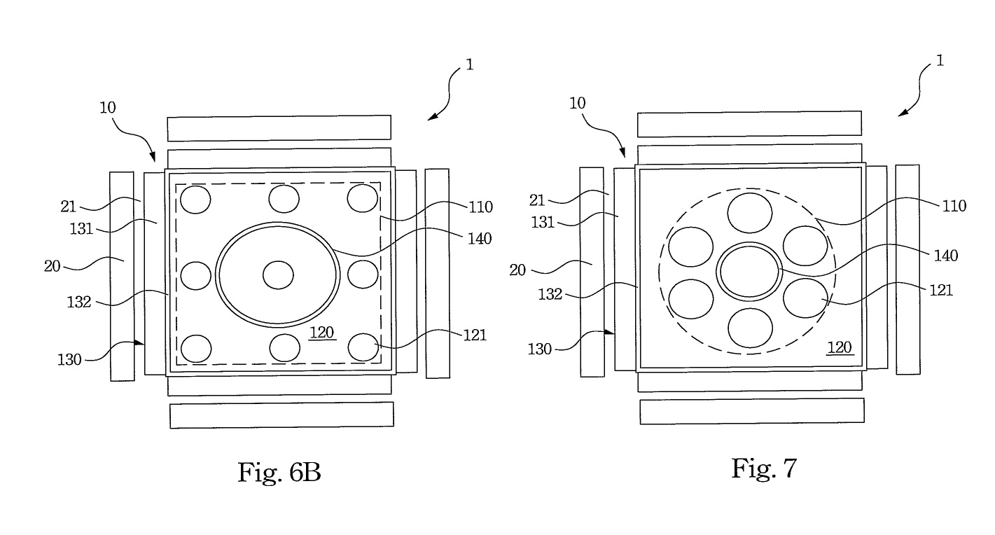

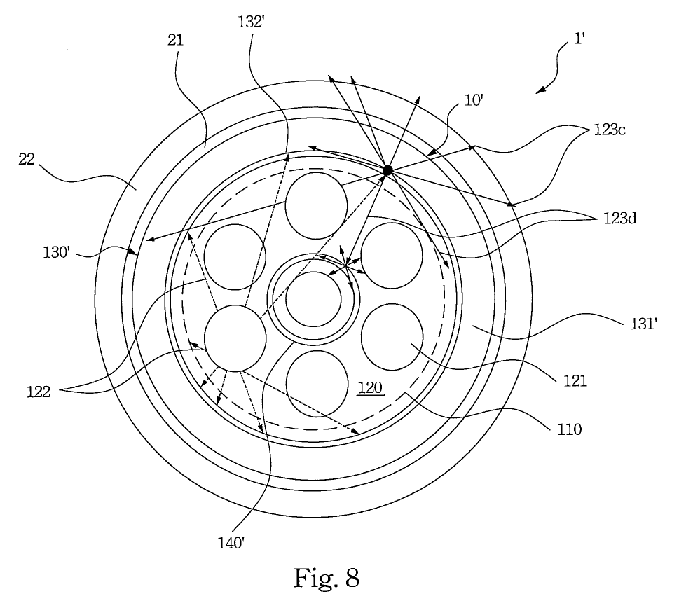

Refer to FIG. 4, FIG. 5, FIG. 6A, FIG. 6B and FIG. 7. FIG. 4, FIG. 5, FIG. 6A, FIG. 6B and FIG. 7 illustrate different arrangements of the luminous elements 121 in different shapes in the present invention. In the first embodiment, those different arrangements of the UVC lamps and their wavelength converters 130 are discussed below:

i. Arranged in an Array (see FIG. 4 and FIG. 2 Again):

The UVC lamps in the lamp holder 110 usually accommodate a dual-screened displayer. In this embodiment the UVC lamps are aligned in one or multiple rows. In view of that, the wavelength converter 130a and 130b are respectively placed against the UVC lamps and facing the UVC lamps in order to converting the ultraviolet light.

ii. Arranged in a Staggered Order (see FIG. 5):

To improve the arrangement of the UVC lamps in the array, the UVC lamps are aligned in for example two rows and the UVC lamps in one row are respectively staggered with the UVC lamps in other row. Also, by controlling the distance between the UVC lamps and the corresponding wavelength converter 130, the UVC lamps in the staggered order can overcome, or at least relieve the “Mura Effect” which presents uneven illumination generated by the UVC lamps.

Refer to FIG. 5. A first distance measured between each UVC lamp of the first row and the top wavelength converter 130 is “a” unit and a second distance measured between each UVC lamp of the first row and the bottom wavelength converter 130 is “b” unit. On the other hand, a third distance measured between each UVC lamp of the second row and the top wavelength converter 130 is “b′” units and a fourth distance measured between each UVC lamp of the second row and the bottom wavelength converter 130 is “a′” units. Because the “a” unit (or “a′” unit) is shorter than “b” unit (or “b′” unit), gaps between every two UVC lamps of the same row (the first or second row) may cause “Mura Effect” to the corresponding wavelength converter 130 but every UVC lamp of the other row (the second or first row) will provide complementary illumination through the gaps between every two UVC lamps of the row (the first or second row) to relieve the unbalanced illumination.

Also, this arrangement of the UVC lamps can enable users to deal with different illumination demands for each screen. Namely, if “a” unit is unequal to “a′” unit and “b” unit is unequal to “b′” unit, thus, by adjusting the distances between each UVC lamp of the same row and the corresponding wavelength converters 130 respectively, users can magnify or minify the strength of the illumination emitted from the UVC lamps to each screen.

iii. Arranged as a Polygonal Shape (see FIG. 6A and FIG. 6B):

FIG. 6A is a schematic view of an arrangement of the luminous elements in a triangular shape and FIG. 6B is a schematic view of an arrangement of the luminous elements in a rectangular shape in the present invention. In this arrangement, the UVC lamps can be arranged as different polygonal shapes (e.g. triangular shape, rectangular shape and pentagonal shape etc.) to provide illumination for multiple viewing aspects. At least one side of the polygonal shapes that the UVC lamps arrange may face an wavelength converter 130. Thus, the arrangement of the UVC lamps fits a displayer characterized with more than three screens.

Furthermore, refer to FIG. 6B again, at least one wavelength converter 140 with the flexible optical element for the substrate (not shown) is curvedly arranged in the light source 120 and at least embracing one UVC lamp or CCFL.

Thus, the wavelength converter 140 also converts the incoming light with invisible optical wavelengths (i.e. light 122 with the first wavelength in FIG. 2) into light with the aimed optical wavelength (i.e. lights 123a, 123b, 124a and 124b in FIG. 2) and the portion of the light with the aimed optical wavelength (i.e. lights 123a, 123b, 124a and 124b in FIG. 2) will be emitted to the rest wavelength converters 130 for complementary illumination.

iv. Arranged as a Ring Shape (see FIG. 7):

FIG. 7 is a schematic view of an arrangement of the luminous elements in a ring shape in the present invention. In this arrangement, these UVC lamps in the lamp holder 110 usually accommodates for a multi-screened displayer. These UVC lamps are arranged as a ring shape and facing the wavelength converters 130 that encircle the lamp holder 110, so that the wavelength converters 130 convert the light with invisible optical wavelength from these UVC lamps into the light with the aimed optical wavelength, and the light with the aimed optical wavelength is allowed to provide illumination to each screen.

Furthermore, refer to FIG. 7 again, at least one wavelength converter 140 with the flexible optical element for the substrate (not shown) is curvedly arranged in the light source 120 and at least embracing one UVC lamp or CCFL.

Thus, the wavelength converter 140 also converts the coming light with invisible optical wavelength (i.e. light 122) into light with the aimed optical wavelength (i.e. lights 123a, 123b, 124a and 124b in FIG. 2) and the portion of the light with the aimed optical wavelength (i.e. lights 123a, 123b, 124a and 124b in FIG. 2) will be radially emitted to the rest wavelength converters 130 for complementary illumination.

In the first embodiment, the flat panel displayer 1 for the backlight module 10 can be a multi-screened displayer such as dual screened displayer or tri-screened displayer, and the flat panel displayer 1 has some display panels 20, normally liquid crystal display panel. These display panels 20 can be equipped in the flat panel displayer 1 in many arrangements according to the forgoing arrangements of the UVC lamps. These display panels 20 can be arranged in parallel, as polygons or in a ring shape to encircle a holding space 21 inside to contain the backlight module 10. Each of the wavelength converters 130 of the backlight module 10 corresponds to one of the display panels 20. Therefore, the backlight module 10 provides light 123a, 123b, 124a and 124b with the second wavelength to each of the display panels 20 to uniform the illumination for the screen and solves the “Mura Effect” problem.

Refer to FIG. 8. FIG. 8 is a schematic view of a flat panel displayer according to a second embodiment of the present invention. In the second embodiment, the wavelength converter 130′ is single and has a flexible optical element for its substrate 131. Thus, the wavelength converter 130′ is circular and placed to surround the luminous elements 121 and neighboring the lamp holder 110. Also, another wavelength converter 140′ is placed among the luminous elements 121 of the light source 120.

After the UVC lamps in the second embodiment radially emit the ultraviolet light (refer to light 122 with a first wavelength in FIG. 8) to the wavelength converter 130′ individually, the converting layer 132′ of the wavelength converter 130′ converts the ultraviolet light (i.e. light 122 in FIG. 8) into light with the aimed optical wavelength (refer to lights 123c and 123d with a second wavelength in FIG. 8).

Note that a portion of the light with the aimed optical wavelength (i.e. the portion light 123c) will be emitted outward directly from a position of the wavelength converter 130′, and the other portion of the light with the aimed optical wavelength (i.e. the light 123d in FIG. 8) will be radially emitted from the position thereof to the other positions of the wavelength converter 130′. When the other portion of the light with the aimed optical wavelength (i.e. the light 123d in FIG. 8) arrives at the other positions thereof, the other portion of the light with the aimed optical wavelength (i.e. the light 123d) provides complementary illumination to enhance the portion of the light with aimed optical wavelength (i.e. the light 123c). Thus, the backlight module 10′ uniformly provides illumination to the wavelength converter 130′ of the flat panel displayer 1′.

Furthermore, these UVC lamps in the lamp holder 110 can be arranged as a polygonal shape, an array, a ring shape or in a staggered order as long as the wavelength converter 130 surrounds the lamp holder 110 (or even only the UVC lamps) and facing the UVC lamps with its converting layer 132′. Thus, every position of the converting layer 132′ will convert the ultraviolet light (i.e. light 122 in FIG. 8) into light with the aimed optical wavelength (i.e. lights 123c and 123d in FIG. 8).

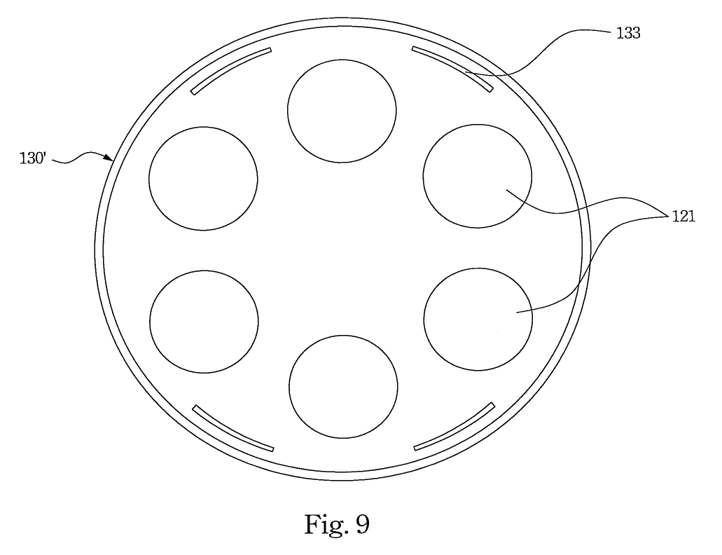

Thus, the substrate 131′ of the wavelength converter 130 prefer to be a flexible optical element such as an optical diffuser film, a brightness enhancement film, a dual brightness enhancement film and multiple layers of theirs combinations thereof. The flexible optical element can be supported by some supporter 133. (See FIG. 9)

In the second embodiment, the flat panel displayer 1′ for the backlight module 10′ can be a round-surfaced display panel and has a single circular display panel 22, normally a flexible display panel. The circular display panel 22 encircles a holding space 21 inside that contains the backlight module 10′. Therefore, the UVC lamps arranged as one of the forgoing arrangements, the backlight module 10′ provides uniform illumination to the circular display panel 22 to solve the “Mura Effect” problem.

It must be noticed that the portion of the light 123a, 123c and 124a and the other portion of the light 123b, 123d and 124b are only convenient for illustration the movement of the converted light; otherwise, they are the same light with the second wavelength.

The present invention of backlight module must implement the wavelength converter neighboring the light source to convert the radiate light with the first type of wavelength into the light with the second type of wavelength, and to launch the light with the second type of wavelength in radiation direction. Thus, the present invention overcomes the problem of “Mura Effect” happened on illumination, raising the brightness by shortening the distance between the luminous elements and the wavelength converter to also downsize the flat panel displayer in dimension.

Although the present invention has been described in considerable detail with reference in the certain preferred embodiments thereof, other embodiments do not only limit the number of the wires and the conductive pins to the mentioned information above. The number of the wires and the conductive pins can be modified based on the realistic demands. Therefore, the spirit and scope of the appended claims should not be limited to the description of the preferred embodiments contained herein.

What is claimed is:

1. A backlight module installed in a flat panel display, the backlight module comprising:
a light source formed by arranging a plurality of luminous elements radially emitting a light with a first wavelength individually; and
a plurality of wavelength converters disposed adjacent to the light source, each of the wavelength converters respectively converting the light with the first wavelength into a light with a second wavelength and radially emitting the light with the second wavelength,
wherein a portion of the light with the second wavelength is emitted outward directly from the wavelength converter, while the other portion thereof is emitted from the wavelength converter toward the other wavelength converters.

2. The backlight module as claimed in claim 1, wherein the wavelength converters comprises:
a plurality of substrates; and
a plurality of converting layers attached on the substrates, each of the converting layers made by materials selected from the group consisting of phosphor power, sensitization substance, fluorescent color converting medium, organic complex substance, sensitizing dye, quantum dot based substance, quantum wire based substance, quantum well based substance and a combination thereof.

3. The backlight module as claimed in claim 2, wherein each of the substrates is a stiff optical element, and the stiff optical element is selected from the group consisting of a diffusion plate, a prism plate, a lenticular sheet, an optical polarizing plate and a combination thereof.

4. The backlight module as claimed in claim 3 further comprises a plurality of supporters supporting the substrates.

5. The backlight module as claimed in claim 2, wherein each of the substrates is a flexible optical element, and the flexible optical element is selected by an optical diffuser film, a bright enhance film, a dual bright enhance film and the combinations thereof.

6. The backlight module as claimed in claim 2, wherein each of the substrates is made by materials selected from the group consisting of plastic, rubber, glass, quartz and the combinations thereof.

7. The backlight module as claimed in claim 7, wherein the material of the plastic is selecting from the group consisting of poly(methyl methacrylate) (PMMA), polystyrene (PS), methyl methacrylate-co-styrene (MS), polycarbonate (PC), Polyethylene Terephthalate (PET), polyimide and a combination thereof.

8. The backlight module as claimed in claim 1, wherein each of the luminous elements is a short wavelength ultraviolet lamp.

9. The backlight module as claimed in claim 9, wherein the light with the first wavelength is a light with an invisible optical wavelength, and the light with the second wavelength is a light with an aimed optical wavelength.

10. The backlight module as claimed in claim 9, wherein the short wavelength ultraviolet lamps are arranged in a polygonal shape.

11. The backlight module as claimed in claim 9, wherein the short wavelength ultraviolet lamps are arranged as an array.

12. The backlight module as claimed in claim 9, wherein the short wavelength ultraviolet lamps are arranged in a staggered order.

13. The backlight module as claimed in claim 9, wherein the short wavelength ultraviolet lamps are arranged as a ring shape.

14. The backlight module as claimed in claim 9, wherein some of the wavelength converters surround the light source and face the short wavelength ultraviolet lamps.

15. The backlight module as claimed in claim 14, wherein one of the wavelength converters is curly disposed in the light source and surrounds at least one short wavelength ultraviolet lamp.

16. The backlight module as claimed in claim 1, wherein each of the luminous elements is a blue light LED.

17. The backlight module as claimed in claim 16, wherein the light with the first wavelength is light with a blue ray wavelength, and the light with the second wavelength is light with a white ray wavelength.

18. A flat panel display, comprising:
a plurality of display panels encircling a holding space; and
a backlight module as claimed in claim 1 disposed in the holding space,
wherein each of the wavelength converters of the backlight module corresponds to one of the display panels and provides the light with the second wavelength for all of the display panels.

19. The flat panel display as claimed in claim 18, wherein the flat panel display is a liquid crystal display with multiple screens, and the display panels encircling as a polygonal shape.

20. The flat panel display as claimed in claim 18, wherein the flat panel display is a liquid crystal display with multiple screens, and the display panels encircling as a ring shape.

21. A backlight module installed in a flat panel display, the backlight module comprising:
a light source formed by an arrangement of a plurality of luminous elements radially emitting light with a first wavelength individually; and
a circular wavelength converter surrounding the light source, the wavelength converter converting the light with the first wavelength into light with a second wavelength and radially emitting the light with the second wavelength when the light with the first wavelength arrives at every position of the wavelength converter,
wherein a portion of the light with the second wavelength is emitted outward directly from a position of the wavelength converter, while the other portion thereof is emitted from the position of the wavelength converter toward the rest positions of the wavelength converter.

22. The backlight module as claimed in claim 21, wherein the wavelength converters comprises:
at least one substrate; and
at least one converting layer attached on the substrate, wherein the at least one converting layer is made by materials selected from the group consisting of phosphor power, sensitization substance, fluorescent color converting medium, organic complex substance, sensitizing dye, quantum dot based substance, quantum wire based substance, quantum well based substance and a combination thereof.

23. The backlight module as claimed in claim 22, wherein the at least one substrate is a stiff optical element, and the stiff optical element is selected from the group consisting of a diffusion plate, a prism plate, a lenticular sheet, an optical polarizing plate and a combination thereof.

24. The backlight module as claimed in claim 23 further comprises a plurality of supporters supporting the at least one substrate.

25. The backlight module as claimed in claim 22, wherein the at least one substrate is a flexible optical element, and the flexible optical element is selected by an optical diffuser film, a bright enhancement film, a dual bright enhancement film and a combination thereof.

26. The backlight module as claimed in claim 25 further comprises a plurality of supporters supporting the at least one substrate.

27. The backlight module as claimed in claim 22, wherein the at least one substrate is made by materials selected from the group consisting of plastic, rubber, glass, quartz and a combination thereof.

28. The backlight module as claimed in claim 27, wherein the material of the plastic is selecting from the group consisting of poly(methyl methacrylate) (PMMA), polystyrene (PS), methyl methacrylate-co-styrene (MS), polycarbonate (PC), Polyethylene Terephthalate (PET), polyimide and a combination thereof.

29. The backlight module as claimed in claim 21, wherein each of the luminous elements is a short wavelength ultraviolet lamp.

30. The backlight module as claimed in claim 29, wherein the light with the first wavelength is a light with an invisible optical wavelength, and the light with the second wavelength is a light with an aimed optical wavelength.

31. The backlight module as claimed in claim 30, wherein the short wavelength ultraviolet lamps are arranged in a polygonal shape, an array, a ring shape or in a staggered order.

32. The backlight module as claimed in claim 30 further comprises the other one wavelength converter curly disposed in the light source and surrounding at least one short wavelength ultraviolet lamp.

33. The backlight module as claimed in claim 21, wherein each of the luminous elements is a blue light LED.

34. The backlight module as claimed in claim 33, wherein the light with the first wavelength is a light with a blue ray wavelength, and the light with the second wavelength is a light with a white ray wavelength.

35. A flat panel display, comprising:
a circular display panel encircling a holding space; and
a backlight module as claimed in claim 21 disposed in the holding space,
wherein the wavelength converter of the backlight module faces the circular display panel and provides the light with the second wavelength for the circular display panel.
